(19) United States
(12) Patent Application Publication
(10) Pub. No.: US 2006/0082074 A1
(43) Pub. Date: Apr. 20, 2006

(54) Circumferential feather seal

(75) Inventors: Remy Synnott, St. Jean-sur-Richelieu (CA); David Glasspoole, St. Lambert (CA)

Correspondence Address: OGILVY RENAULT LLP (PWC), 1981 MCGILL COLLEGE AVENUE, SUITE 1600, MONTREAL, QC, H3A 2Y3, CA

(73) Assignee: Pratt & Whitney Canada Corp.

(21) Appl. No.: 10/965,782

(22) Filed: Oct. 18, 2004

(51) Int. Cl. F16J 15/02

(52) U.S. Cl. 277/641

(57) ABSTRACT

A seal arrangement between a vane assembly and a static shroud assembly reduces gas path leakage and beneficially improves gas turbine performance.

### FIELD OF THE INVENTION

The present invention relates to gas turbine engines, and particularly to seal means for the air leakage existing between the outer shroud of the rotor blades and adjacent stator vane shroud.

### BACKGROUND OF THE INVENTION

It is well-known to be undesirable to have uncontrolled air leakage between the shrouds of a vane ring and an adjacent turbine static shroud because leakage is a loss of energy and adverse to fuel economy.

Various arrangements for sealing such leakages have been proposed, such as a continuous seal ring provided between successive shrouds. Due to the high temperature working condition of a gas turbine, the continuous seal ring requires a low thermal expansion in order to ensure an adequate seal. However, such a seal will be adversely affected when successive shrouds have different thermal expansions during engine operation. Therefore there is a need for improved seal means which will be more adequate under high temperature working conditions of gas turbine engines.

### SUMMARY OF THE INVENTION

One object of the present invention is to provide an improved seal configuration.

In accordance with one aspect of the present invention, there is provided a seal assembly for minimizing fluid leakage between an end of an annular vane assembly and an end of an annular static shroud assembly of a gas turbine engine. The seal assembly comprises a primary seal comprised of co-operating abutting radial surfaces of the vane assembly and static shroud assembly and a secondary seal including a feather seal received within a cavity, the cavity being at least partially formed between two annular recesses defined in the radial abutting surfaces.

In accordance with another aspect of the present invention, there is provided a turbine stator structure comprising an annular upstream shroud having a continuous circumferential downstream end, an annular downstream shroud coaxial with the upstream shroud, having a continuous circumferential upstream end abutting the downstream end of the upstream shroud to thereby provide a primary seal between the shrouds. Opposed circumferential recesses are defined in the respective abutting ends of the shrouds, thereby forming an annular cavity crossing a boundary between the abutting ends. A sealing ring is received within the cavity, abutting an annular axial surface of the cavity to substantially cover a line of the boundary on the annular axial surface.

In accordance with further aspect of the present invention, there is provided a seal assembly for minimizing fluid leakage between a turbine vane assembly and a turbine static shroud assembly, the vane and shroud assemblies having planar radially-extending annular surfaces facing one another, the seal assembly comprising annular recesses defined in the respective annular surfaces, and a feather seal extending between the recesses. The feather seal preferably extends substantially around but is less than a complete circumference of the annular recesses to thereby permit interference-free circumferential thermal expansion of the feather seal.

The present invention advantageously provides a simple seal configuration for minimizing a radial fluid leakage between successive shrouds without being substantially affected by thermal expansion of either the metal seal ring or the shrouds, and will provide an adequate seal even when the successive shrouds have the same or different thermal expansions. These and other advantages of the present invention will be better understood with reference to preferred embodiments of the present invention to be described hereinafter.

### BRIEF DESCRIPTION OF THE DRAWINGS

Reference will now be made to the accompanying drawings showing by way of illustration preferred embodiments, in which:

FIG. 1 is a schematic cross-sectional view of a turbofan gas turbine engine, as an example illustrating an application of the present invention;

FIG. 2 is a partial cross-sectional view of a turbine section of the engine of FIG. 1, showing a first embodiment of the present invention;

FIG. 2A is a cross-sectional view of the embodiment of FIG. 2;

FIG. 3 is a partial cross-sectional view of FIG. 2 in an enlarged scale, showing details of the embodiment;

FIG. 4 is a partial cross-sectional view similar to FIG. 3, showing thermal expansions during engine operation;

FIG. 5 is a partial cross-sectional view similar to FIG. 3, showing an alternative configuration according to a second embodiment of the present invention;

FIG. 6 is a partial cross-sectional view similar to FIG. 3, showing a further alternative configuration according to a third embodiment of the present invention;

FIG. 7 is a partial cross-sectional view similar to FIG. 3, showing a still further alternative configuration according to a fourth embodiment of the present invention; and

FIG. 8 is a partial cross-sectional view similar to FIG. 3, showing a still further alternative configuration according to a fifth embodiment of the present invention.

### DETAILED DESCRIPTION OF THE PREFERRED EMBODIMENTS

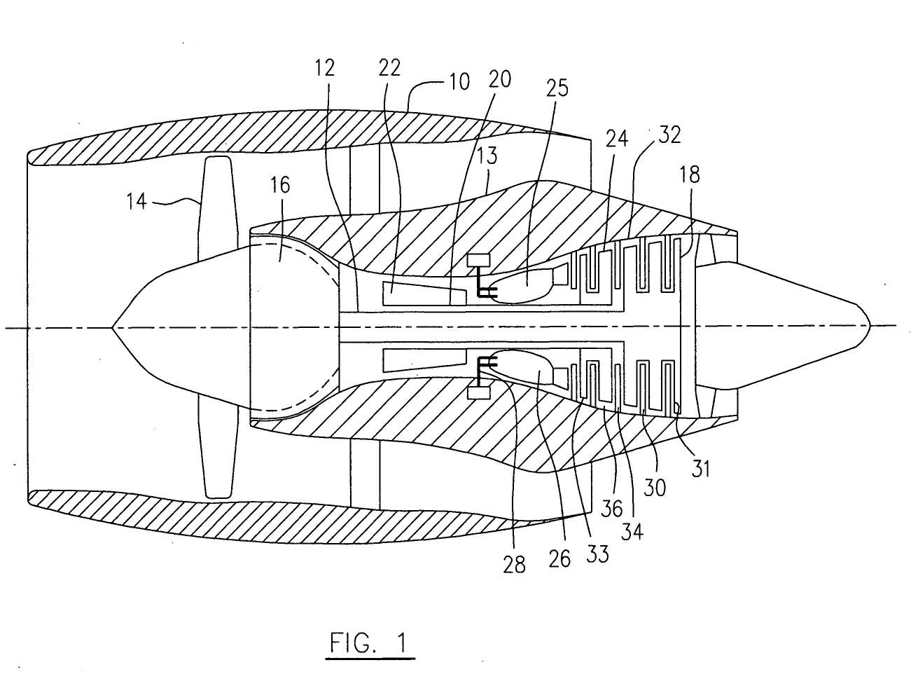

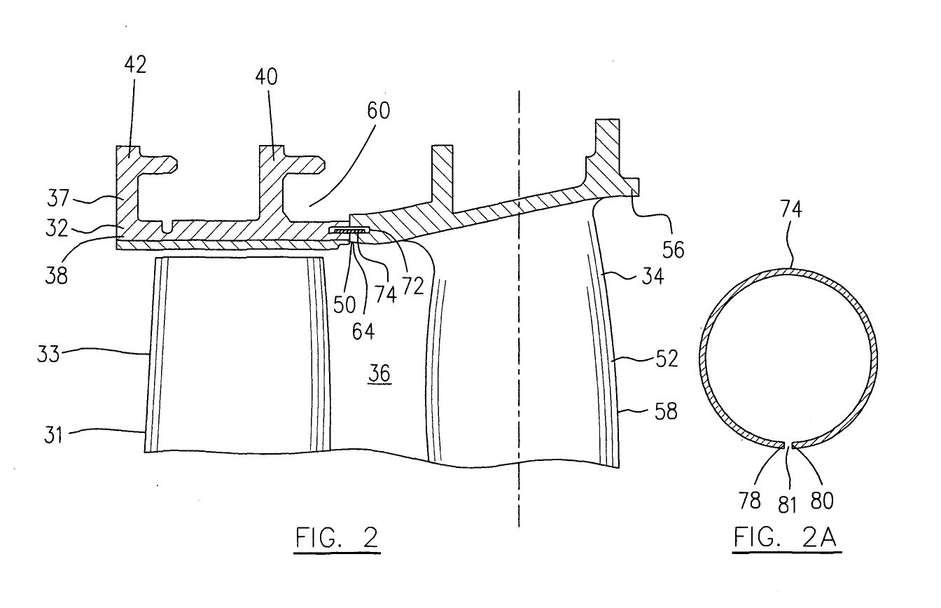

Referring to FIGS. 1 and 2, a turbofan gas turbine engine incorporating an embodiment of the present invention is presented as an example of the application of the present invention, and includes a housing or a nacelle 10, a core casing 13, a low pressure spool assembly seen generally at 12 which includes a fan 14, low pressure compressor 16 and low pressure turbine 18, and a high pressure spool assembly seen generally at 20 which includes a high pressure compressor 22 and a high pressure turbine 24. There is provided a combustor seen generally at 25 which includes an annular combustor 26 and a plurality of fuel injectors 28 for mixing liquid fuel with air and injecting the mixed fuel/air flow into the annular combustor 26 to be ignited for generating combustion gases. The low pressure turbine 18 and high pressure turbine 24 include a plurality of stator vane stages 30 and rotor stages 31. Each of the rotor stages 31 has a plurality of rotor blades 33 encircled by a shroud assembly 32 and each of the stator vane stages 30 includes a stator vane assembly 34 which is positioned upstream and/or downstream of a rotor stage 31, for directing combustion gases into or out of an annular gas path 36 within a corresponding shroud assembly 32, and through the corresponding rotor stage 31.

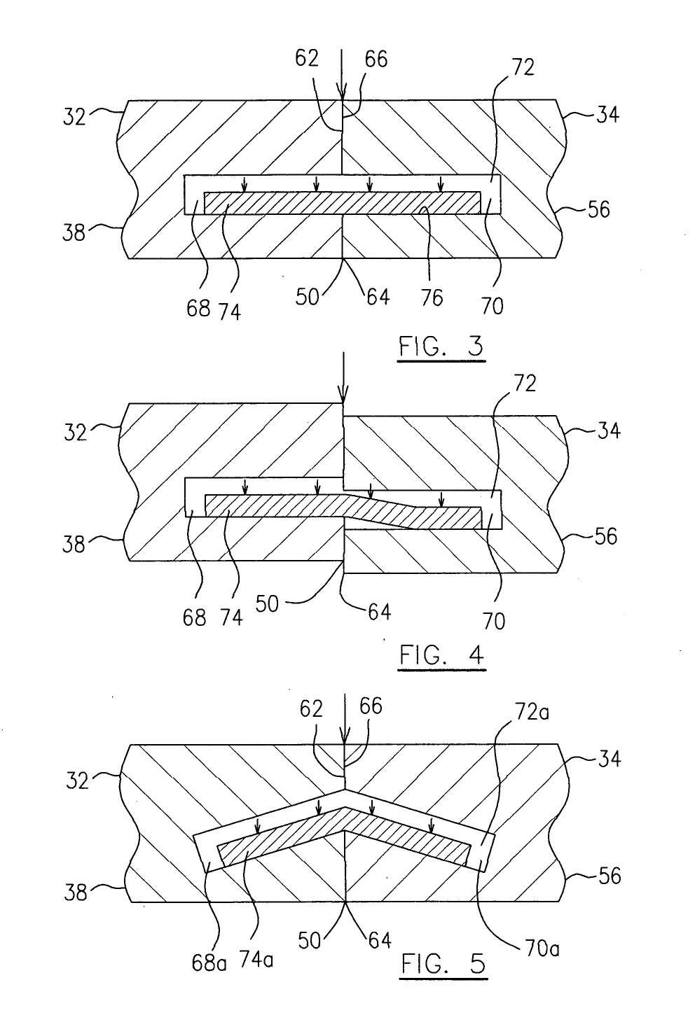

Referring to FIGS. 2, 2A and 3, a combination of the turbine shroud assembly 32 and the stator vane assembly 34 is described. The shroud assembly 32 includes a plurality of shroud segments 37 (only one shown) each of which includes a shroud ring section 38 having two radial legs 40, 42 with respective hooks (not indicated) conventionally supported within an annular shroud support structure (not shown) formed with a plurality of shroud support segments. The annular shroud support structure is in turn supported within the core casing 13 of FIG. 1. The shroud segments 37 are joined one to another in a circumferential direction and thereby form the shroud assembly 32 which encircles the rotor blades 33 and in combination with the rotor stage 31 defines a section of an annular gas path 36. The shroud assembly 32 includes an upstream end (not indicated) and a downstream end 50.

The stator vane assembly 34 is disposed, for example, downstream of the rotor stage 31, and includes a plurality of stator vane segments 52 (only one shown) joined one to another in a circumferential direction. The stator vane segments 52 each include an inner platform (not shown) conventionally supported on a stationary support structure (not shown) and an outer platform referred to as a stator vane shroud segment 56 to form a stator vane shroud which is conventionally supported within the annular shroud support structure. One or more (only one shown) air foils 58 radially extending between the inner platform and the stator vane shroud segment 56 divide a downstream section of the annular gas path 36 relative to the rotor stage 31, into sectoral gas passages for directing combustion gas flow out of the rotor stage 31.

Compressed cooling air (as indicated by the arrows in FIG. 2) is introduced within the shroud support structure to cool the shroud assembly 32 and the stator vane assembly 34. The pressure of the cooling air within a cavity 60 defined between the shroud support structure and the shroud assembly 32 as well as the stator vane assembly 34, is referred to as a “vane feed pressure” and is higher than the pressure of the combustion gas in the annular gas path 36 which is referred to as the “gas path pressure”. Therefore, it is desirable to provide a seal between the shroud assembly 32 and the stator vane shroud of the stator vane assembly 34 in order to impede cooling air flow from leaking into the gas path 36, which causes cooling air to be wasted and thereby adversely affects engine performance efficiency and part durability.

The downstream ends of the respective shroud ring section 38 in combination form the continuously circumferentially downstream end 50 of the shroud assembly 32, preferably having a substantially flat radial surface 62 thereof. Similar to the shroud ring section 38, the upstream ends of the respective stator vane shroud segments 56 in combination, form a continuous and circumferential upstream end 64 of the stator vane shroud of the stator vane assembly 34, preferably having a substantially flat radial surface 66. The substantially flat annular radial surface 62 of the shroud downstream end 50 abuts the substantially flat annular radial surface 66 of the upstream end 64 of the stator vane shroud, thereby providing a primary seal to prevent air leakage between the successive shroud assembly 32 and the stator vane assembly 34, into the gas path 36.

Nevertheless, air leaking passages to an extent exist between the successive shroud assembly 32 and the stator vane assembly 34 through the primary seal formed by the abutting flat annular radial surfaces 62, 66, due to various factors such as manufacturing tolerances, thermal expansion, etc. In order to further minimize air leakage between the successive shroud assembly 32 and the stator vane assembly 34, a secondary seal is provided.

Each of the shroud segments 37 includes a groove (not indicated) extending circumferentially from one side to the other through the downstream end thereof, thereby defining an annular recess 68 in the downstream end 50 of the shroud assembly 32 which extends from the substantially flat annular radial surface 62 into the downstream end 50. A groove (not indicated) is also provided in each of the stator vane shroud segments 56, extending from one side to the other through the upstream end thereof, thereby defining an annular recess 70 which extends from the substantially flat annular radial surface 66 of the upstream end 64 of the stator vane shroud of the stator vane assembly 34. The two annular recesses 68, 70 are substantially aligned with each other to form an annular cavity 72.

A sealing ring 74 is received within the annular cavity 72. The feather seal 74 in the embodiment shown in FIGS. 2, 2A and 4, preferably includes a feather seal having a curved metal band having a generally rectangular cross-section loosely received within the annular cavity 72. Therefore, under the pressure differential between the vane feed pressure in the cavity 60 and the gas path pressure in the annular gas path 36, the seal 74 is pressed radially inwardly, (as shown by the arrows in FIG. 3 representing the air pressure differential) to abut an annular axial surface 76 of the annular cavity 72. Because the annular cavity 72 crosses a boundary between the abutting ends 50, 64 of the successive shroud assembly 32 and stator vane shroud of the stator vane assembly 34, the seal 74 substantially covers a line of the boundary (not indicated) on the annular axial surface 76, thereby minimizing a radial fluid leakage through those fluid leaking passages formed between the abutting ends 50, 64 of the successive shroud assembly 32 and stator vane shroud of the stator vane assembly 34. Seal 74 may comprise a plurality of seal segments (not shown) circumferentially arranged, if desired.

The seal 74 as shown in FIG. 2A, includes opposed ends 78, 80 defining a very small gap 81 therebetween to allow for thermal expansion thereof. The small gap 81 will cause a very small air leakage therebetween, the quantity of which may be accurately determined and controlled. Nevertheless, the seal 74 preferably provides a secondary seal in addition to the primary seal formed between the abutting annular radial surfaces 62, 66, and therefore the leakage through the small gap 81 is insignificant enough to be ignored. However, if desired, the seal 74 may provide a primary seal between the vane and static shroud, which will be further described below with reference to FIG. 7.

The shroud assembly 32 has a substantially different configuration from the stator vane shroud of the stator vane assembly 34. In the stator vane assembly 34, the stator vane shroud segments 56 may be integrated with one or more air foils 58. Therefore, the thermal expansion of the shroud assembly 32 may be different from that of the stator vane shroud of the stator vane segments 34 during engine operation. Furthermore, due to the different configurations, the shroud ring segments 37 and the stator vane shroud segments 56 may be fabricated in different materials which also results in different thermal expansions during engine operation. As shown in FIG. 4, different thermal expansions of the shroud assembly 32 and stator vane shroud of the stator vane assembly 34 will cause a radial displacement therebetween, which results in misalignment of the two annular recesses 68, 70. Due to the loose accommodation of the seal 74 and the very thin cross-section thereof which results in flexibility, the seal 74 under the pressure differential as shown by the arrows, will still substantially seal the line of the boundary between the ends 50, 64. In contrast to the seal 74 of the present invention, continuous seal rings used in prior art have a tendency to keep the diameter thereof equal at two sides thereof, which results in difficulties to substantially seal the line of the boundary of the abutting ends 50, 64 when the annular recesses 68, 70 are misaligned.

In other embodiments described below, similar parts are identified with numerals similar to those of the description of the first embodiment and will not be redundantly described.

The annular cavity and the seal of the present invention can be in various cross-sections. For example, in accordance with a second embodiment of the present invention and illustrated in FIG. 5, an annular cavity 72a is formed by two annular recesses 68a, 70a which are at angles to each other. The seal 74a includes a circumferentially extending seal which is angled along a central axis (not indicated) such that the two sides thereof are angled to correspond with angled orientation of the two annular recesses 68a and 70a.

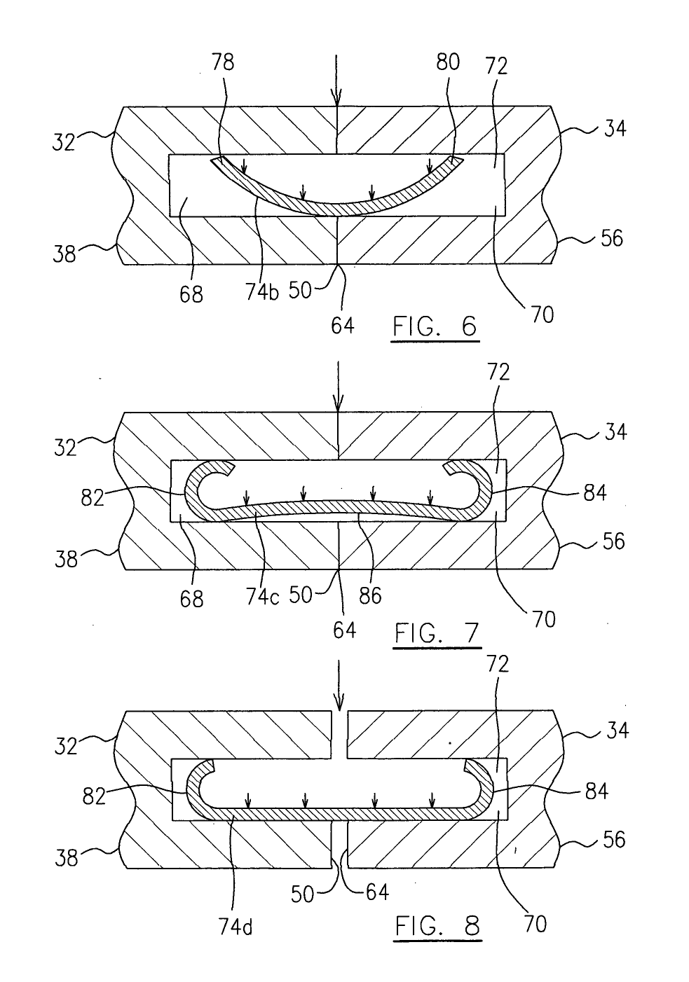

FIG. 6 illustrates a third embodiment of the present invention in which the seal 74b includes a circumferentially extending seal having a curved cross-section such that the opposite sides 78, 80 thereof, have a diameter greater than the diameter of the middle portion therebetween.

FIG. 7 illustrates a fourth embodiment of the present invention in which the seal 74c includes a circumferentially extending seal having two side portions 82, 84 curved radially outwardly with a radially outwardly arched middle portion 86, to form a “dog bone” shaped cross-section.

FIG. 8 illustrates a fifth embodiment of the present invention in which the seal 74d, similar to the embodiment of FIG. 7, includes a circumferentially extending seal having opposed side portions 82, 84 curved preferably radially and outwardly. However, the middle portion (not indicated) between the curved side portions 82, 84 of the seal 74d, is preferably generally flat, in contrast to the arched profile of the embodiment of FIG. 7. It is noted that the ends 50, 64 of the respective shroud assembly 32 and stator vane assembly do not a but one another, leaving a gap therebetween. This embodiment illustrates the applicability of the present invention when the shroud assembly 32 and stator vane assembly 34 do not provide a primary seal therebetween. In this embodiment, the seal 74c provides primary sealing between the adjacent turbine components.

The seals 74b, 74c and 74d in FIGS. 6-8 present a further aspect of the present invention. The cross-sectional dimension of the seals 74b, 74c and 74d is smaller in width than the annular cavity 72, but the seals 74b, 74c and 74d are not loosely received within the annular cavity 72 due to the specifically profiled cross-sections thereof. When the seals 74b, 74c and 74d are placed within the annular cavity 72, the opposed sides 78, 80 of the seal 74b or the opposed curved side portions 82, 84 of the seals 74c and 74d, are compressed within the annular cavity 72, resulting in a resilient deformation thereof which produces a radial pre-load to the seals 74b, 74c and 74d. This radial pre-load advantageously ensures an effective seal of the seals 74b, 74c and 74d over the line of the boundary of the abutting ends 50, 64 of the successive shroud assembly 32 and the stator vane shroud of the stator vane assembly 34, even when the pressure differential between the vane feed pressure in the cavity 60 and the gas path pressure in the annular gas path 36 of FIG. 2 is relatively small. These pre-load types of seals 74b, 74c and 74d are also adapted to compensate for misalignment of the annular recesses 68, 70 resulting from different thermal expansions of the shroud assembly 32 and the stator vane shroud of the stator vane assembly 34. This feature is assisted by flexible nature of the seal configuration, as disclosed above.

The above-described embodiments are exemplary and are not intended to limit the present invention. Modifications and improvements to the above-described embodiments may made without departure from the principle of the present invention. For example, the seal configuration according to the present invention can be applied to any successive annular components of a gas turbine engine such as successive sections of a fan blade casing or compressor portion of a gas turbine engine. The present invention can also be applicable to gas turbine engine types other than turbofan turbine engines. Therefore the scope of the present invention is intended to be limited solely by the scope of the appended claims.

1. A seal assembly for minimizing fluid leakage between an end of an annular vane assembly and an end of a annular static shroud assembly of a gas turbine engine, the seal assembly comprising:
a primary seal comprised of co-operating abutting radial surfaces of the vane assembly and static shroud assembly; and
a secondary seal including a feather seal received within a cavity, the cavity being at least partially formed between two annular recesses defined in the radial abutting surfaces, the feather seal having a substantially flat cross-sectional configuration under a fluid pressure differential thereacross to abut an axial annular surface of the cavity and substantially cover a boundary between the co-operating abutting radial surfaces of the vane assembly and static shroud assembly.

2. The seal assembly as claimed in claim 1 wherein the feather seal member is spaced apart from a bottom end of at least one of the annular recesses.

3. The seal assembly as claimed in claim 1 wherein the feather seal extends substantially around but is less than a complete circumference of the annular recesses to thereby permit interference-free circumferential expansion thereof.

4. The seal as claimed in claim 1 wherein the feather seal comprises a cross-section dimension to be loosely received within the cavity.

5. The seal assembly as claimed in claim 1 wherein the feather seal comprises means for generating a mechanical pre-load on the seal in a radial direction when being placed in position.

6. The seal assembly as claimed in claim 5 wherein the feather seal comprises a circumferentially extending thin metal band to form the substantially flat cross-sectional configuration.

7. A turbine stator structure comprising:
an annular upstream shroud having a continuous circumferential downstream end;
an annular downstream shroud coaxial with the upstream shroud, having a continuous circumferential upstream end abutting the downstream end of the upstream shroud to thereby provide a primary seal between the shrouds;
opposed circumferential recesses defined in the respective abutting ends of the shrouds, thereby forming an annular cavity crossing a boundary between the abutting ends; and
a sealing ring received within the cavity, the sealing ring having a substantially flat cross-sectional configuration under a fluid pressure differential generated during turbine operation, the substantially flat cross-sectional configuration abutting an annular axial surface of the cavity to substantially cover a line of the boundary on the annular axial surface.

8. The turbine stator structure as claimed in claim 7 wherein the seal ring comprises a band extending substantially around but is less than a complete circumference of the annular cavity to thereby permit interference-free circumferential thermal expansion thereof.

9. The turbine stator structure as claimed in claim 7 wherein the seal ring comprises a cross-section dimension to be loosely received within the cavity.

10. The turbine stator structure as claimed in claim 7 wherein the seal ring comprises means for generating a mechanical pre-load on the seal ring in a radial direction.

11. The turbine stator structure as claimed in claim 10 wherein the seal ring comprises a circumferentially extending thin metal band to form the substantially flat configuration.

12. A seal assembly for minimizing fluid leakage through a passage between a turbine vane assembly and a turbine static shroud assembly, the vane and shroud assemblies having planar radially-extending annular surfaces facing one another, the seal assembly comprising annular recesses defined in the respective radially extending annular surfaces, and a feather seal extending between the recesses, the feather seal having a substantially flat cross-sectional configuration under a fluid pressure differential generated during turbine operation to substantially abut adjacent axial surfaces of the respective recesses and substantially cover the passage, wherein the feather seal extends substantially around but is less than a complete circumference of the recesses to thereby permit interference-free circumferential thermal expansion of the feather seal.

13. The seal assembly of claim 12 wherein the feather seal comprises a thin metal band.
